(19) United States
(12) Patent Application Publication
(10) Pub. No.: US 2021/0327040 A1
(43) Pub. Date: Oct. 21, 2021

(54) MODEL TRAINING METHOD AND SYSTEM FOR AUTOMATICALLY DETERMINING DAMAGE LEVEL OF EACH OF VEHICLE PARTS ON BASIS OF DEEP LEARNING

(71) Applicant: AGILESODA INC., Seoul (KR)

(72) Inventors: Tae Youn KIM, Seoul (KR); Jin Sol EO, Hanam-si (KR); Byung Sun BAE, Seoul (KR)

(73) Assignee: AGILESODA INC., Seoul (KR)

(21) Appl. No.: 17/362,120

(22) Filed: Jun. 29, 2021

Related U.S. Application Data
(63) Continuation of application No. PCT/KR2019/018699, filed on Dec. 30, 2019.

(30) Foreign Application Priority Data
Dec. 31, 2018 (KR) 10-2018-0174110
Jun. 21, 2019 (KR) 10-2019-0073936

(51) Int. Cl. G06T 7/00; G06N 3/08

(52) U.S. Cl. CPC G06T 7/001; G06N 3/08; G06T 2207/30252; G06T 2207/20084; G06T 2207/20081

(57) ABSTRACT

The present invention relates to a method and a system for training a model for automatically determining the degree of damage for each vehicle area based on deep learning, which generate a model capable of quickly calculating a consistent and reliable vehicle repair quote by learning so as to automatically extract a picture in which it is possible to determine the degree of damage among accident vehicle pictures by using the Mask R-CNN framework and the Inception V4 network structure based on deep learning, and learning the degree of damage for each type of damage.

### CROSS-REFERENCE TO RELATED APPLICATIONS

The present application is a continuation of International Patent Application No. PCT/KR2019/018699, filed on Dec. 30, 2019, which claims priority to and the benefit of Korean Patent Application Nos. 10-2018-0174110 and 10-2019-0073936 filed in the Korean Intellectual Property Office on Dec. 31, 2018 and June 21, 2019, respectively, the entire contents of which are incorporated herein by reference.

### TECHNICAL FIELD

The present invention relates to a method and a system for training a model for automatically determining the degree of damage for each vehicle area based on deep learning, and more particularly, to a method and a system for training a model for automatically determining the degree of damage for each vehicle area based on deep learning, which generate a model capable of quickly calculating a consistent and reliable vehicle repair quote by learning so as to automatically extract a picture in which it is possible to determine the degree of damage among accident vehicle pictures by using the Mask R-CNN framework and the Inception V4 network structure based on deep learning, and learning the degree of damage for each type of damage.

### BACKGROUND ART

In general, when a vehicle is damaged due to various factors, such as a traffic accident, the damaged vehicle is put into a repair shop and the degree of damage of the vehicle is determined according to the judgement of a maintenance expert. In this case, because the standard for determining the degree of damage for each maintenance expert is not standardized and subjective judgement is involved, there are cases in which repair cost estimates vary greatly even though the degree of damage is similar.

Accordingly, there is a need for technology that can establish reliable repair cost estimates based on standardized and consistent judgement standard, not the subjective judgement standards for determining the degree of damage of maintenance experts.

### DISCLOSURE

### Technical Problem

The present invention is conceived to solve the foregoing problems, and is to provide a method and a system for training a model for automatically determining the degree of damage for each vehicle area based on deep learning, which generate a model capable of quickly calculating a consistent and reliable vehicle repair quote by learning so as to automatically extract a picture in which it is possible to determine the degree of damage among accident vehicle pictures by using the Mask R-CNN framework and the Inception V4 network structure based on deep learning, and learning the degree of damage for each type of damage.

### Technical Solution

An exemplary embodiment of the present invention provides a method of training a model for automatically determining a degree of damage for each vehicle area based on deep learning, the method including: generating a first model by learning data that selects some of the vehicle photographed images among a plurality of first vehicle photographed images; generating a second model by learning data obtained by recognizing and subdividing each component by using a plurality of second vehicle photographed images; generating a third model which inspects and relabels damage degree labelling data based on a result of a comparison between the damage degree labelling data for each type of damage for the plurality of vehicle photographed images determined by a user and a reference value; and generating a fourth model by learning data obtained by determining the degree of damage for each type of damage of the plurality of damaged area photographed images.

In the exemplary embodiment, the generating of the first model includes removing a vehicle photographed image that is determined to correspond to a vehicle photographed image obtained by photographing a state of the vehicle after an accident repair or determined to correspond to a vehicle photographed image that is out of focus among the plurality of first vehicle photographed images based on a result value of a comparison between a plurality of vehicle photographed images obtained by photographing a state of the vehicle before the accident repair and a plurality of vehicle photographed images obtained by photographing the state of the vehicle after the accident repair.

In the exemplary embodiment, the generating of the second model may include learning data obtained by recognizing and subdividing vehicle components for a bumper, a door, a fender, a trunk, and a hold in the plurality of second vehicle photographed images by using a Mask R-CNN framework.

In the exemplary embodiment, the generating of the third model may include determining and learning a type of damage of the plurality of damaged area photographed images by using an Inception V4 network structure of a CNN framework, and the generating of the fourth model may include learning whether the degree of damage for each type of damage corresponds to any one of a normal state, a scratch state, a small-damage plate work required state, a medium-damage plate work required state, a large-damage plate work required state, and an exchange state by using an Inception V4 network structure of the CNN framework.

Another exemplary embodiment of the present invention provides a system for training a model for automatically determining a degree of damage for each vehicle area based on deep learning, the system including: a first model generating unit which generates a first model by learning data that selects some of the vehicle photographed images among a plurality of first vehicle photographed images; a second model generating unit which generates a second model by learning data obtained by recognizing and subdividing each component by using a plurality of second vehicle photographed images; a third model generating unit which generates a third model which inspects and relabels damage degree labelling data based on a result of a comparison between the damage degree labelling data for each type of damage for the plurality of vehicle photographed images determined by a user and a reference value; and a fourth model generating unit which generates a fourth model by learning data obtained by determining the degree of damage for each type of damage of the plurality of damaged area photographed images.

In the exemplary embodiment, the first model generating unit may remove a vehicle photographed image that is determined to correspond to a vehicle photographed image obtained by photographing a state of the vehicle after an accident repair or determined to correspond to a vehicle photographed image that is out of focus among the plurality of first vehicle photographed images based on a result value of a comparison between a plurality of vehicle photographed images obtained by photographing a state of the vehicle before the accident repair and a plurality of vehicle photographed images obtained by photographing the state of the vehicle after the accident repair.

In the exemplary embodiment, the second model generating unit may learn data obtained by recognizing and subdividing vehicle components for a bumper, a door, a fender, a trunk, and a hold in the plurality of second vehicle photographed images by using a Mask R-CNN framework.

In the exemplary embodiment, the third model generating unit may determine and learn a type of damage of the plurality of damaged area photographed images by using an Inception V4 network structure of a CNN framework, and the fourth model generating unit may learn whether the degree of damage for each type of damage corresponds to any one of a normal state, a scratch state, a small-damage plate work required state, a medium-damage plate work required state, a large-damage plate work required state, and an exchange state by using an Inception V4 network structure of the CNN framework.

### Advantageous Effects

According to an aspect of the present invention, there is an advantage in that a vehicle owner is capable of quickly obtaining a consistent and reliable quote for vehicle repair based on an accident image photographed by himself/herself by using the trained and generated model.

Further, according to an aspect of the present invention, there is an advantage in that it is possible to quickly derive a damage degree determination result based on a deep learning model trained based on several tens of thousands of accident images.

Further, according to an aspect of the present invention, even when a vehicle is damaged due to various reasons, such as a traffic accident, it is not necessary to carry out the process of determining the degree of damage of the vehicle according to the determination by a maintenance expert after putting the damaged vehicle into a repair shop. Accordingly, there is an advantage in that it is possible to effectively prevent the case where the repair cost quote varies greatly despite the similar degree of damage because the standards of determining the degree of damage are not standardized for each maintenance expert and a subjective determination is involved.

### DESCRIPTION OF DRAWINGS

FIG. 1 is a diagram illustrating the configuration of a system 100 for training a model for automatically determining the degree of damage for each vehicle area based on deep learning according to an exemplary embodiment of the present invention.

FIG. 2 is a diagram illustrating a process of training a model for automatically determining the degree of damage for each vehicle area through the system for training the model for automatically determining the degree of damage for each vehicle area based on deep learning illustrated in FIG. 1 in sequence.

### MODE FOR CARRYING OUT THE INVENTION

Hereinafter, an exemplary embodiment is presented for helping the understanding of the present invention. However, the following exemplary embodiment is merely provided for easier understanding of the present invention, and the contents of the present invention are not limited by the exemplary embodiment.

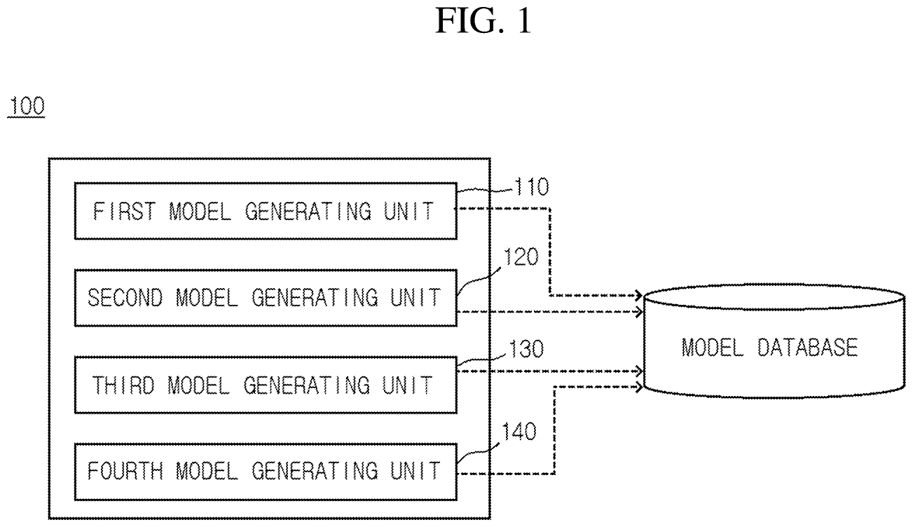

FIG. 1 is a diagram illustrating the configuration of a system 100 for training a model for automatically determining the degree of damage for each vehicle area based on deep learning according to an exemplary embodiment of the present invention.

Referring to FIG. 1, the system 100 for training the model for automatically determining the degree of damage for each vehicle area based on deep learning according to an exemplary embodiment of the present invention generally includes a first model generating unit 110, a second model generating unit 120, a third model generating unit 130, and a fourth model generating unit 140.

The first model generating unit 110 generates a first model by learning data that selects some of the vehicle photographed images among the plurality of first vehicle photographed images.

More particularly, the first model generating unit 110 generates a first model by repeatedly learning data of selecting about 10% (for example, 3 to 4 images) of the vehicle photographed images by removing an image determined to be photographed after the accident repair or a vehicle photographed image that is out of focus because of being photographed too far away among the plurality of first vehicle photographed images (for example, 30 to 40 vehicle photographed images obtained by photographing the accident vehicle in the event of the car accident) based on a result value obtained by comparing a plurality of vehicle photographed images (for example, 50,000 images or more) obtained by photographing the state of the accident vehicle before the accident repair in the event of the vehicle accident with a plurality of vehicle photographed images (for example, 50,000 images or more) obtained by photographing the state of the accident vehicle after the accident repair. This is applicable later to select an image suitable for determining the type of damage and the degree of damage from the plurality of photographed images photographed through a user terminal (for example, a terminal of an owner of the accident vehicle).

The second model generating unit 120 may generate a second model by learning data obtained by recognizing and subdividing each component by using the plurality of second vehicle photographed images.

More particularly, the second model generating unit 120 may learn data obtained by recognizing and subdividing vehicle components for a bumper, a door, a fender, a trunk, and a hood in the plurality of second vehicle photographed images by using the Mask R-CNN framework.

For example, the second model generating unit 120 masks each of the plurality (for example, several tens of thousands) of vehicle photographed images obtained by randomly photographing each part of the front side, the lateral side, and the rear side of the vehicle with different colors for each component, such as the bumper, the door, the fender, the trunk, the hood, and the like through the Mask R-CNN framework, and then learn a location and the type of each component, such as the bumper, the door, the fender, the trunk, and the hood, based on the masked area.

In this case, the masking area does not exactly match the size of each component, such as the bumper, the door, the fender, the trunk, and the hood, but masks an area larger than the size of each component (for example, 110% of the size of each component). Accordingly, the masking is performed so as to cover a boundary of a portion in which the components are in contact with each other or connected to each other, so that the damage to the boundary portion in which the components are adjacent or connected to each other is also recognized.

Further, in relation to the component recognized through the Mask R-CNN framework, the masking is performed based on the components pre-learned through at least several tens of thousands of sample images for each component type, so that other components, other than the learned component, are not detected.

In the meantime, the mask R-CNN framework is the framework developed by Facebook's artificial intelligence research center, and the type of each component may be recognized by masking the components with different colors for each component by using the Mask R-CNN framework.

The third model generating unit 130 generates a third model which compares damage degree labelling data for each type of damage of the damaged area photographed image determined by the user with a reference value, and inspects and relabels the damage degree labelling data in order to obtain the result of determining of the type of damage with high reliability for the plurality of vehicle photographed images obtained by photographing the accident vehicle in the event of the car accident.

Herein, the relabeling refers to a process performed on an assumption that the damage level labelling data determined by the user is not perfect due to human error, and the third model inspects the damage degree labelling data.

First, the third model generating unit 130 generates the third model which outputs a probability of the damaged area estimated to correspond to the corresponding image when a damaged area is classified from a specific damaged area photographed image as result data.

In this case, in order to improve accuracy of the corresponding third model, the third model generating unit 130 determines whether a probability value of the damaged area of the result data output according to the input of the specific damaged area photographed image to the third model is larger or smaller than a reference probability value that is set with a predetermined probability value.

When the probability value of the damaged area of the specific damaged area photographed image is larger than the reference probability value, it is determined that the accuracy of the generated third model is high. In this case, the damage degree labelling data assigned to the corresponding damaged area photographed image by the user is maintained.

On the contrast, when the probability value of the damaged area of the specific damaged area photographed image is smaller than the reference probability value, it is determined that the accuracy of the generated third model is low. In this case, the damage degree labelling data assigned to the corresponding damaged area photographed image by the user is corrected to new damaged degree labelling data.

Through the foregoing method, the relabeling process is performed on all of the damaged area photographed images, so that it is possible to improve the rate of determination of the degree of damage in the damage area photographed image, and whenever the relabeling process is repeatedly performed, performance of the third model is continuously improved. The third model exhibiting the finally improved performance is applicable to the training of a fourth model which is to be described below.

Further, in the exemplary embodiment, in the relabeling process through the third model generating unit 130, the fourth model generating unit 140 which is to be described below may use a softmax value generated through the third model generating unit 130.

The fourth model generating unit 140 generates a fourth model by learning data obtained by determining the degree of damage for each type of damage of the plurality of damaged area photographed images.

More particularly, the fourth model generating unit 140 generates the fourth model by learning the degree of damage for each type of damage based on the plurality (for example, several tens of thousand) of damaged area photographed images (for example, doors with scratches, the fender that needs plate work, and the bumper that needs replacement work). In this case, the fourth model generating unit 140 determines whether the degree of damage of the corresponding damaged area corresponds to any one of a normal state, a scratch state, a small-damage plate work required state, a medium-damage plate work required state, a large-damage plate work required state, and an exchange state by using the Inception V4 network structure of the CNN framework.

In this case, the Inception V4 network structure is developed by the Google's artificial intelligence research center, and the fourth model generating unit learns whether the damaged area corresponds to any one of the normal state, the scratch state, the small-damage plate work required state, the medium-damage plate work required state, the large-damage plate work required state, and the exchange state by using the Inception V4 network structure.

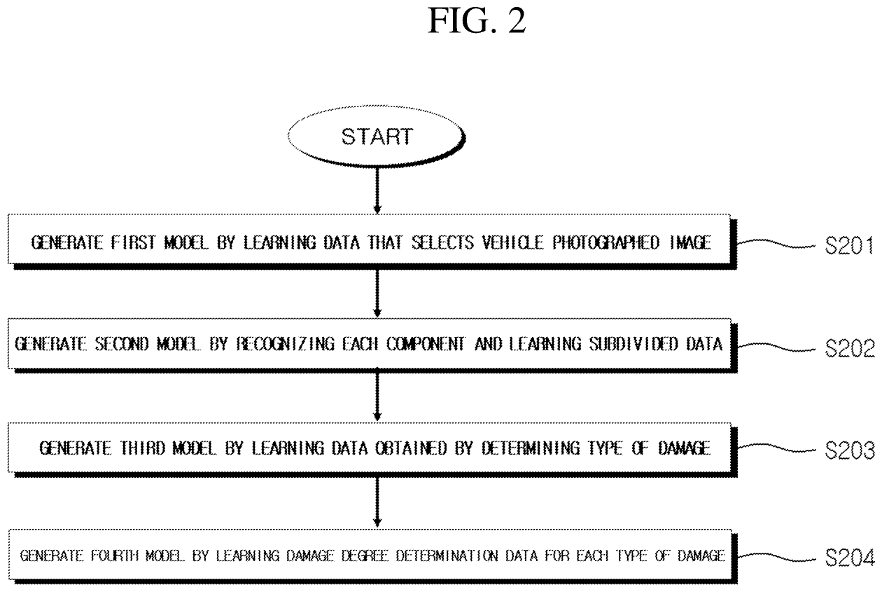

Next, a process of training a model for automatically determining the degree of damage for each vehicle area will be described with reference to FIG. 2.

FIG. 2 is a diagram illustrating a process of training a model for automatically determining the degree of damage for each vehicle area through the system for training the model for automatically determining the degree of damage for each vehicle area based on deep learning illustrated in FIG. 1 in sequence.

Referring to FIG. 2, the first model generating unit learns data that selects some of the vehicle photographed image among the plurality of first vehicle photographed images and generates a first model (S201). In this operation, the first model is generated by repeatedly learning data of selecting about 10% (for example, 3 to 4 images) of the vehicle photographed images by removing an image determined to be photographed after the accident repair or a vehicle photographed image that is out of focus because of being photographed too far away among the plurality of first vehicle photographed images (for example, 30 to 40 vehicle photographed images obtained by photographing the accident vehicle in the event of the car accident) based on a result value obtained by comparing a plurality of vehicle photographed images (for example, 50,000 images or more) obtained by photographing the state of the accident vehicle before the accident repair in the event of the vehicle accident with a plurality of vehicle photographed images (for example, 50,000 images or more) obtained by photographing the state of the accident vehicle after the accident repair.

Next, the second model generating unit learns data obtained by recognizing and subdividing each component by using the plurality of second vehicle photographed images and generates a second model (S202). In this operation, the second model generating unit masks each of the plurality (for example, several tens of thousands) of vehicle photographed images obtained by randomly photographing each part of the front side, the lateral side, and the rear side of the vehicle with different colors for each component, such as the bumper, the door, the fender, the trunk, the hood, and the like through the Mask R-CNN framework, and then learns a location and the type of each component, such as the bumper, the door, the fender, the trunk, and the hood, based on the masked area.

Next, the third model generating unit learns data obtained by determining the type of damage by using the plurality of damaged area photographed images and generates a third model (S203). In this operation, the third model generating unit determines and learns the type of damage in the damaged area photographed image by using the Inception V4 network structure of the CNN framework.

Next, the fourth model generating unit learns data obtained by determining the degree of damage for each type of damage of the plurality of damaged area photographed images and generates a fourth model (S204). In this operation, the fourth model generating unit determines whether the degree of damage of the corresponding damaged area corresponds to any one of a normal state, a scratch state, a small-damage plate work required state, a medium-damage plate work required state, a large-damage plate work required state, and an exchange state by using the Inception V4 network structure of the CNN framework.

In the forgoing, the present invention has been described with reference to the exemplary embodiment of the present invention, but those skilled in the art may appreciate that the present invention may be variously corrected and changed within the range without departing from the spirit and the area of the present invention described in the appending claims.

1. A method for training a model for automatically determining a degree of damage for each vehicle area based on deep learning, the method comprising:
generating a first model by learning data that selects some of the vehicle photographed images among a plurality of first vehicle photographed images;
generating a second model by learning data obtained by masking each component with a different color by using a plurality of second vehicle photographed images, and then recognizing and subdividing a vehicle component for a bumper, a door, a fender, a trunk, and a hood based on the masked area;
generating a third model which inspects and relabels damage degree labelling data based on a result of a comparison between the damage degree labelling data for each type of damage for the plurality of vehicle photographed images determined by a user and a reference value; and
generating a fourth model by learning data obtained by determining the degree of damage for each type of damage of the plurality of damaged area photographed images.

2. The method of claim 1, wherein the generating of the first model includes removing a vehicle photographed image that is determined to correspond to a vehicle photographed image obtained by photographing a state of the vehicle after an accident repair or determined to correspond to a vehicle photographed image that is out of focus among the plurality of first vehicle photographed images based on a result value of a comparison between a plurality of vehicle photographed images obtained by photographing a state of the vehicle before the accident repair and a plurality of vehicle photographed images obtained by photographing the state of the vehicle after the accident repair.

3. The method of claim 1, wherein the generating of the second model includes learning data obtained by recognizing and subdividing vehicle components for a bumper, a door, a fender, a trunk, and a hold in the plurality of second vehicle photographed images by using a Mask R-CNN framework.

4. The method of claim 1, wherein the generating of the third model includes determining and learning a type of damage of the plurality of damaged area photographed images by using an Inception V4 network structure of a CNN framework, and
the generating of the fourth model includes learning whether the degree of damage for each type of damage corresponds to any one of a normal state, a scratch state, a small-damage plate work required state, a medium-damage plate work required state, a large-damage plate work required state, and an exchange state by using an Inception V4 network structure of the CNN framework.

5. A method of automatically determining a degree of damage for each vehicle area based on deep learning, which determines a degree of damage for each vehicle area based on the model generated by using the method of claim 1.

6. A system for training a model for automatically determining a degree of damage for each vehicle area based on deep learning, the system comprising:
a first model generating unit which generates a first model by learning data that selects some of the vehicle photographed images among a plurality of first vehicle photographed images;
a second model generating unit which generates a second model by learning data obtained by masking each component with a different color by using a plurality of second vehicle photographed images, and then recognizing and subdividing each vehicle component for a bumper, a door, a fender, a trunk, and a hood based on the masked area;
a third model generating unit which generates a third model which inspects and relabels damage degree labelling data based on a result of a comparison between the damage degree labelling data for each type of damage for the plurality of vehicle photographed images determined by a user and a reference value; and
a fourth model generating unit which generates a fourth model by learning data obtained by determining the degree of damage for each type of damage of the plurality of damaged area photographed images.

7. The system of claim 6, wherein the first model generating unit removes a vehicle photographed image that is determined to correspond to a vehicle photographed image obtained by photographing a state of the vehicle after an accident repair or determined to correspond to a vehicle photographed image that is out of focus among the plurality of first vehicle photographed images based on a result value of a comparison between a plurality of vehicle photographed images obtained by photographing a state of the vehicle before the accident repair and a plurality of vehicle photographed images obtained by photographing the state of the vehicle after the accident repair.

8. The system of claim 6, wherein the second model generating unit learns data obtained by recognizing and subdividing vehicle components for a bumper, a door, a fender, a trunk, and a hold in the plurality of second vehicle photographed images by using a Mask R-CNN framework.

9. The system of claim 6, wherein the third model generating unit determines and learns a type of damage of the plurality of damaged area photographed images by using an Inception V4 network structure of a CNN framework, and
the fourth model generating unit learns whether the degree of damage for each type of damage corresponds to any one of a normal state, a scratch state, a small-damage plate work required state, a medium-damage plate work required state, a large-damage plate work required state, and an exchange state by using an Inception V4 network structure of the CNN framework.

10. A system for automatically determining a degree of damage for each vehicle area based on deep learning, which determines a degree of damage for each vehicle area based on the model generated by using the system of claim 6.
